(19) United States
(12) Patent Application Publication
(10) Pub. No.: US 2026/0099041 A1
(43) Pub. Date: Apr. 9, 2026

(54) SPATIALLY-DECOHERED CHANNEL METASURFACE

(71) Applicant: STMicroelectronics International N.V., Geneva (CH)

(72) Inventors: Jemma Elizabeth CALLAGHAN, Edinburgh (GB); James Peter Drummond DOWNING, Doune (GB)

(73) Assignee: STMicroelectronics International N.V., Geneva (CH)

(21) Appl. No.: 18/906,684

(22) Filed: Oct. 4, 2024

(51) Int. Cl. G02B 26/10; G01S 7/481; G01S 17/89; G02B 1/00

(52) U.S. Cl. CPC G02B 26/101; G01S 7/4817; G01S 17/89; G02B 1/002; G02B 2207/101

(57) ABSTRACT

Disclosed herein is an optical system that combines optics with a one-dimensional scanner to achieve two-dimensional scanning. The system includes a light source emitting a beam, which is steered in one dimension by a scanner. The optics then convert this one-dimensional scan into a two-dimensional scan across the target scene. The optics comprises multiple distinct optical channels integrated into a single surface, each designed to manipulate light in a specific manner. This arrangement allows for precise control over beam direction, size, and shape, enabling selective illumination of scene elements and adaptable scanning patterns. The system also incorporates a detector and control circuitry to generate a depth map of the scene.

### TECHNICAL FIELD

This disclosure relates to the field of light detection and ranging (LIDAR) systems. In particular, this disclosure relates to the design and manufacture of metasurfaces for use in LIDAR applications to achieve two-dimensional scanning from one-dimensional input.

### BACKGROUND

Light Detection and Ranging (LIDAR) sensing technology, particularly for applications such as autonomous vehicles, requires beam steering modules that are both reliable and capable of providing a large field of view (FOV) in two dimensions. LIDAR systems work by emitting laser pulses and measuring the time it takes for the light to reflect off objects and return to the sensor, using this measured time to calculate distance to the objects, and then creating detailed 3D maps of the surrounding environment. The ability to rapidly and accurately steer these laser beams is of interest for creating high-resolution, real-time scans. However, existing beam steering solutions, whether mechanical or solid-state, face limitations in terms of FOV coverage and repeatability.

Recent advancements in solid-state steering, such as optical phased arrays (OPAs) and liquid crystal metasurfaces, have shown improvements in repeatability, but these often come at the cost of a more limited FOV or the ability to scan in only one dimension. These solid-state technologies, while promising, face challenges in achieving the wide angular coverage desired for many LIDAR applications.

On the other hand, Micro-Electro-Mechanical Systems (MEMS) steering approaches offer a wider FoV, often in two dimensions, but struggle with repeatability issues. MEMS systems typically use tiny mirrors that can be tilted using electrostatic or electromagnetic forces to steer the laser beam. While these systems can achieve relatively large scanning angles, they are susceptible to various environmental factors, including temperature fluctuations and ambient vibrations, as well as stress from repeated use. These factors can lead to inconsistencies in beam positioning over time, affecting the accuracy and reliability of the LIDAR system.

Galvanometer scanners use a motor to rotate a mirror back and forth around an axis, providing beam steering in one dimension. For two-dimensional scanning, two galvanometer scanners are used in combination, with one scanning horizontally and the other vertically.

Polygon scanners, on the other hand, use a rotating polygon-shaped mirror to reflect and steer the laser beam. As the polygon rotates, each facet deflects the beam at a slightly different angle, creating a scanning line. By combining this with a second scanning mechanism, such as a galvanometer scanner for the vertical direction, a two-dimensional scan can be achieved.

While these galvanometer and polygon scanning systems are relatively insensitive to vibrations compared to MEMS approaches, they tend to be larger in size, which can be a disadvantage in applications where compact form factors are crucial. Moreover, they can propagate errors due to rotational motion and angle irregularity, which in turn affects their repeatability. Other issues include wobble, where slight variations in the orientation of the mirror facets can lead to inconsistencies in the scan pattern, and jitter, where small fluctuations in rotation speed can cause irregularities in the timing and positioning of laser pulses. Additionally, as mechanical systems, they are subject to wear and tear over time, which can affect their performance and reliability.

Given these challenges, it would be desirable to develop a solid-state steering mechanism capable of achieving a larger FoV across two dimensions. Further development is therefore needed.

### SUMMARY

This disclosure relates to an optical system including specialized optics for use in various applications including, but not limited to, LIDAR systems and optical switching in telecommunications and/or data communications, enabling two-dimensional scanning from a one-dimensional input. The optics include multiple channels, each designed to redirect light to a different specific position in a target scene. This permits creation of a compact, high-performance optical component capable of optical a 1D scanning input into a 2D scanning pattern, enhancing the capabilities of LIDAR systems while reducing mechanical complexity.

### BRIEF DESCRIPTION OF THE DRAWINGS

FIG. 1 is a diagrammatical representation of a LIDAR system incorporating a Spatially-Decohered Channel Metasurface (SDCMS).

FIG. 2 illustrates the operation of the SDCMS in redirecting light from a 1D scan to create a 2D scanning pattern.

FIG. 3 is a flowchart illustrating the design and manufacturing process for the SDCMS.

FIG. 4 shows an example of a desired intensity distribution in the target scene.

FIG. 5 depicts the phase profile of the optical function to achieve the desired target intensity pattern.

FIG. 6 illustrates the correction phase profile based on a refractive prism for angle of incidence correction.

FIG. 7 shows the combined phase profile accounting for both desired light redistribution and non-normal incidence of input light.

FIG. 8 is a graph showing the relationship between the top radius of nanostructures and their transmission and phase characteristics for an optimized 450 nm grid library.

FIG. 9 is a diagrammatical representation of a diffractive optical element that could be used in place of the SDCMS in FIG. 1.

### DETAILED DESCRIPTION

The following disclosure enables a person skilled in the art to make and use the subject matter described herein. The general principles outlined in this disclosure can be applied to embodiments and applications other than those detailed above without departing from the spirit and scope of this disclosure. It is not intended to limit this disclosure to the embodiments shown, but to accord it the widest scope consistent with the principles and features disclosed or suggested herein.

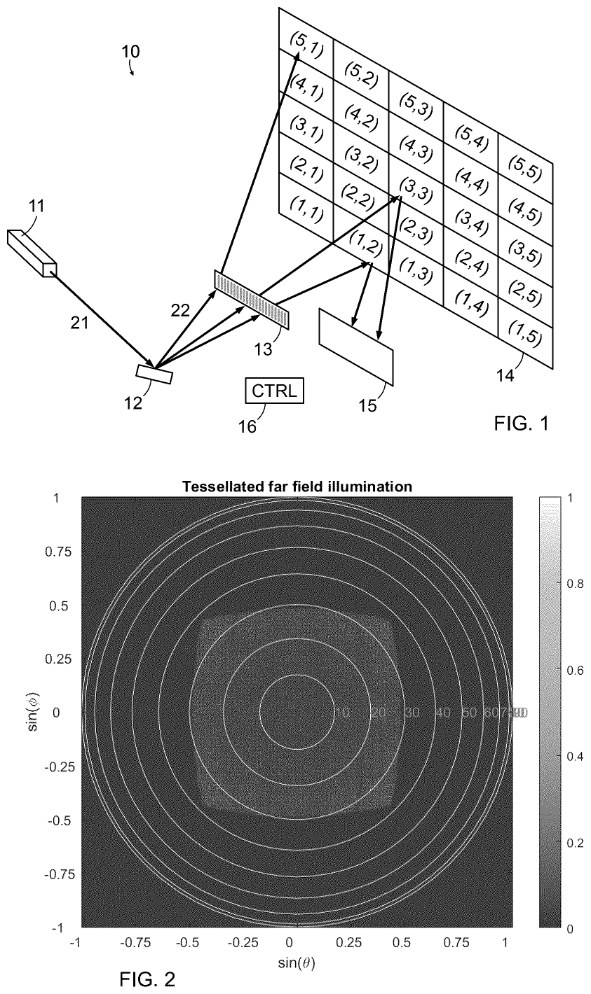

Referring to FIG. 1, a diagrammatical representation of an optical system 10 is shown. The system combines specialized optics 13 with a one-dimensional scanner 12 to achieve two-dimensional scanning capability. The 1D scanner 12 steers an incoming light beam 21 in a single dimension, such as horizontally, across the specialized optics 13. The specialized optics 13 then convert this one-dimensional scan into a two-dimensional scan across the scene, with light reflecting back from the scene returning to a detector 15. Control circuitry 16 reads the detector 15 output to generate a depth map of the scene, thus completing the full optical system functionality.

The 1D scanner 12 can be implemented using a variety of different technologies, including a MEMS mirror, a spatial light modulator (SLM), an optical phased array (OPA), a liquid crystal grating, or a binary grating.

For full understanding, an active metasurface, such as one made of germanium-antimony-tellurium (GST), is a thin, engineered surface comprised of subwavelength structures that can dynamically manipulate electromagnetic waves. GST metasurfaces can rapidly switch between amorphous and crystalline states when heated, allowing for dynamic control of optical properties.

An optical phased array (OPA) is a device that uses an array of optical elements, such as waveguides or antennas, to control the direction of the incident light beam 21 without mechanical movement. Each element in the array can adjust the phase of the light beam 21 passing through it. By controlling the phase shift applied by each element, the OPA can constructively and destructively interfere with the wavefront of the light, effectively steering the light beam 21 in different directions. A liquid crystal grating is a device that uses liquid crystals to create a tunable diffraction grating. By applying an electric field, the orientation of the liquid crystals can be changed, altering the grating pattern and thus the direction of the diffracted light.

A binary grating is a simple form of diffraction grating with two levels of surface relief, comprised of periodic structures that alternate between two heights or refractive indices. While not tunable like liquid crystal gratings, binary gratings can be used for fixed beam steering in certain applications.

The light beam 21 is emitted from a light source 11. In LIDAR applications, this source may be a laser operating at a specific wavelength in the infrared range, such as 855 nm or 940 nm.

The specialized optics 13 are now described, but first, the concept of a metasurface is explained. A metasurface is an ultra-thin optical component composed of an array of subwavelength structures, commonly referred to as nanostructures. These nanostructures, which are smaller than the wavelength of the incident light, can be fabricated from various materials, such as metals or dielectrics. When light interacts with these nanostructures, it undergoes localized modifications at the nanoscale level. The nanostructures are specifically designed and arranged to modify properties of the incident light, including its phase, amplitude, and polarization. Phase modification occurs as the nanostructures introduce varying delays to different parts of the light wavefront. Amplitude modification involves the selective enhancement or suppression of light intensity at different points across the metasurface. Polarization modification allows the nanostructures to alter the orientation of the electric field oscillations of the light. These modifications are achieved through resonant interactions between the incident light and the nanostructures. The resonant properties of each nanostructure are determined by its size, shape, material composition, and arrangement within the array.

The specialized optics may be implemented as a Spatially-Decohered Channel Metasurface (SDCMS) or a Spatially-Decohered Channel Optics (SDCO). A SDCMS is a specialized type of optic that integrates multiple distinct optical channels into a single surface. Each channel is designed to manipulate light in a specific, predetermined manner, with the direction of the input light being decoupled from the direction of the output light. This spatial decoupling allows for control over the output light direction regardless of the angle of incidence. In the optical system 10, the specialized optics 13 convert the one-dimensional scan of the light beam 21 performed by the 1D scanning system 11 into a larger field of view (FOV) two-dimensional scan. As the 1D steering mechanism 12 sweeps the incoming light beam 21 across the specialized optics 13, a complex interaction occurs. Each channel of the specialized optics 13 redirect the light to a different horizontal and/or vertical position in the target scene, represented by the grid 14. This grid 14 can be thought of as being divided into multiple sections, with each section representing a specific discrete location that can be individually addressed by the specialized optics 13. In the illustrated embodiment, the scene is divided into a 5×5 grid, creating 25 distinct addressable locations, although the actual number of sections can be adjusted based on the specific application of the lidar system 10.

The specialized optics 13 may not only redirect the beam but my also shape it. Through specific design of the metasurface structures, the system can control the size and shape of the beam spot on each grid element. For example, the metasurface may incorporate diffusion mechanisms to ensure that each whole grid element is covered by as much of the beam as desired - see for example FIG. 2 showing the output from the specialized optics 13, where each grid element is fully covered by the beam.

The above-described diffusion can be tuned to achieve the desired spot size and coverage for each application. Also, the specialized optics 13 allow for selective illumination of specific grid elements within the target array. This means that not all grid elements need to be illuminated; instead, arbitrary illumination patterns can be achieved. Some grid elements may be fully illuminated while others remain dark, or varying degrees of illumination can be applied across the target scene. Additionally, the illuminated areas are not necessarily confined to single grid elements. The specialized optics 13 may even be designed to allow for overlapping coverage between adjacent grid elements.

This advanced control over the light beam enables the optical system to achieve high-resolution, adaptable scanning patterns while maintaining a compact and efficient design. By directing light to specific grid elements and controlling beam characteristics for each element, the system provides significant advantages in terms of power efficiency, resolution, and adaptability to different sensing scenarios. The ability to selectively illuminate grid elements and control the beam properties for each element allows for scanning strategies that can be tailored to the specific desired of various applications.

In the current embodiment, the specialized optics 13 are arranged for use at 855 nm, which is near the operational wavelength of 940 nm used in some LIDAR systems. A 450 nm grid structure within the specialized optics 13 has been found to perform effectively. Additionally, a wide-angle anti-reflective coating may be applied to the specialized optics 13 to improve overall performance and reduce unwanted reflections. The illustrated implementation of the specialized optics 13 was designed for a 2D scene of 25 target sections across a 500×500 mm area, with a 80° diagonal FOV and correcting for AOI of ±8.19° in the scanning direction. However, as can be appreciated, the system can be adapted for various scene sizes, number of targets, FOV ranges, and AOI corrections to suit specific use cases.

The combination of the 1D scanning system 10 and the specialized optics 13 allows for a compact 2D scanning system that provides a large field of view in two dimensions while maintaining the advantages of solid-state components. This addresses the trade-off in beam steering between FOV and repeatability. By integrating with a solid-state 1D steering module, the 1D scan is converted into a larger FOV scan with 2D coverage, achieving improved repeatability without compromising field of view. The specialized optics 13 provides control over the direction of the output light and therefore the illumination of the scene, due to its spatially-decoupled arrangement in the instance where it is implemented as a SDCMS or SDCO, for example. The discretized channel structure increases usability and reduces alignment constraints, as each channel has a flat metasurface profile that performs as intended as long as light hits at the intended AOI anywhere within the channel. This design is suitable for infrared applications.

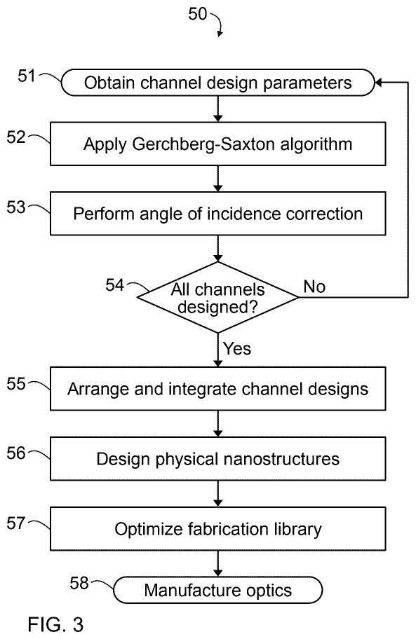

A method of designing and manufacturing the specialized optics 13 are now described with reference to flowchart 50 of FIG. 3. The process involves multiple steps, each contributing to the creation of the specialized optics.

The first step in the process is to obtain the design parameters for each channel of the specialized optics (Block 51). These parameters include the desired light intensity distribution in the target scene for each channel, corresponding to different horizontal and/or vertical positions in the grid 14. Additionally, this step involves determining the specific angle of incidence for each channel based on its position in the SDCMS and its interaction with the steering mechanism 12.

The directional functionality of each channel is designed using an iterative phase-retrieval algorithm which utilizes design phase profiles that produce the desired light intensity distributions in the target plane, based upon the parameters obtained in step 51.

The phase profile for each channel of the SDCMS can be designed using various optimization techniques. While the Gerchberg-Saxton (GS) algorithm is one commonly used method, note that other approaches can also be effective. Such approached may include, for example, gradient descent algorithms, artificial intelligence and machine learning techniques, simulated annealing, and iterative Fourier transform algorithms.

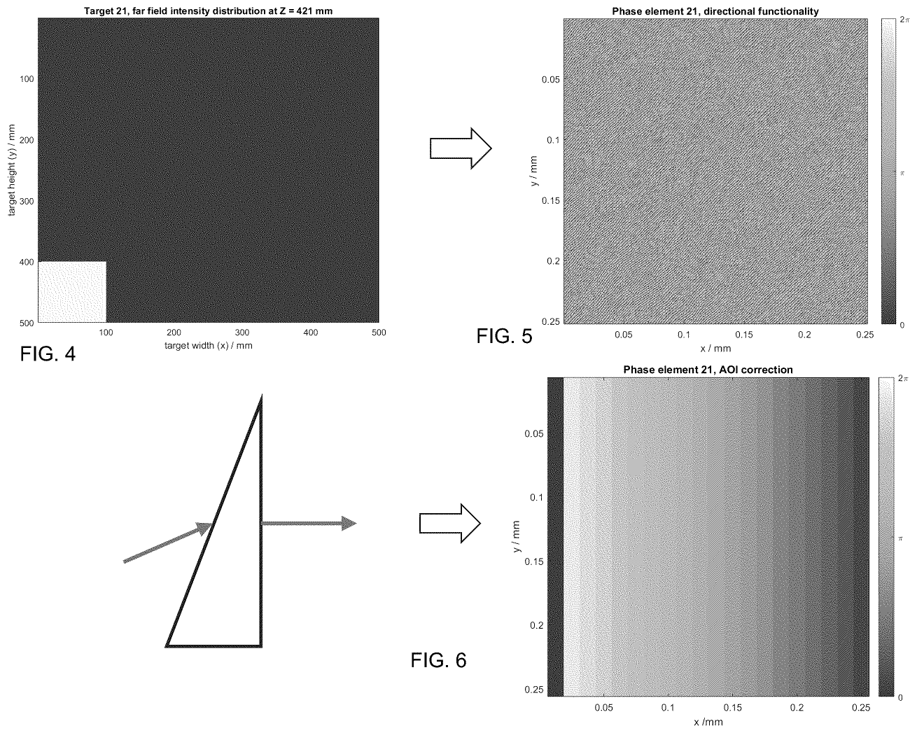

An example will be described using the GS algorithm. The GS algorithm operates by utilizing two intensity-only images separated by a unitary lossless transformation, such as a Fourier Transform (FT). In this application, these two images represent the desired intensity distribution in the target scene (see FIG. 4) and its corresponding diffraction pattern in the Fourier plane (see FIG. 5), which corresponds to the metasurface plane.

This step begins with the desired intensity image of the scene and an initial random phase distribution. It then performs a series of iterative steps:
1. An Inverse Fourier Transform is performed on the complex far field intensity distribution to obtain the field in the metasurface plane.
2. In the metasurface plane, the calculated phase is retained, but the amplitude is replaced with a constant value.
3. A Fourier Transform is performed to compute the far field intensity distribution (target scene).
4. In the far field, the calculated phase is retained, but the amplitude is replaced with the square root of the desired intensity distribution.

These steps are repeated until the algorithm converges on a phase distribution that, when applied to the incident light, would produce the desired intensity distribution in the target plane under normal incidence.

After obtaining the initial phase distribution from the GS algorithm, the next step is to correct for the non-normal angle of incidence of the input light (Block 53). This correction is necessary because the GS algorithm assumes normal incidence, but in practical applications, the light from the steering mechanism 12 is incident at an angle.

The angle of incidence (AOI) correction is performed using an analytical phase solution. This solution is a mathematical expression that directly describes the phase profile needed to correct for non-normal incident light. The correction phase profile is based on that of a refractive prism that could be used to deflect light by the required angle (see FIG. 6).

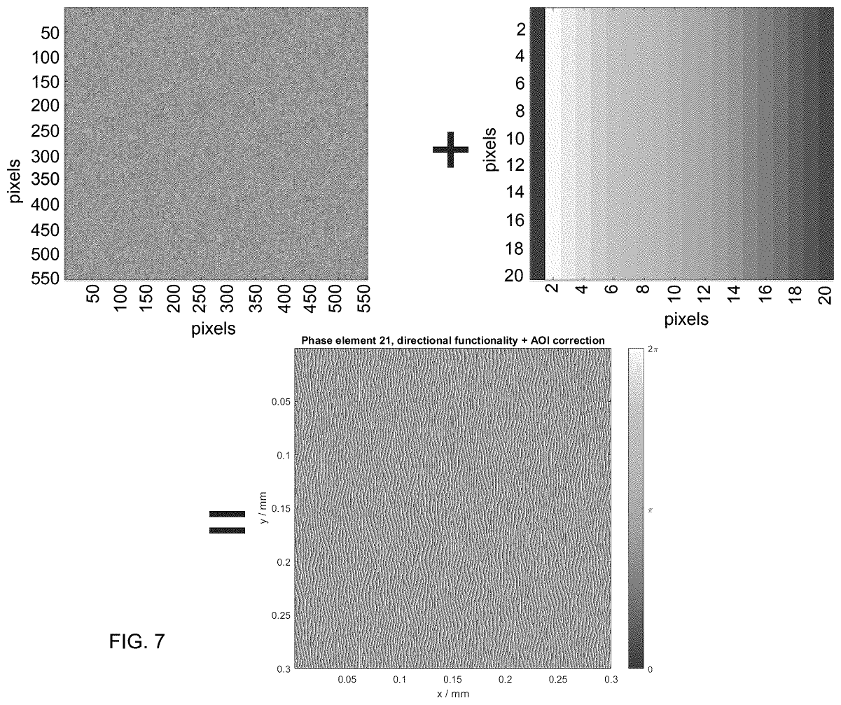

This correction phase profile is added to the phase profile obtained from the GS algorithm. The resulting combined phase profile accounts for both the desired light redistribution and the non-normal incidence of the input light (see FIG. 7).

At this point, the process checks if all channels of the specialized optics have been designed (Block 54). If not, the process returns to step 51 to obtain design parameters for the next channel, and steps 52 and 53 are repeated for that channel. This loop continues until all 25 channels of the SDCMS have been designed.

Once all individual channel designs are complete, the next step is to integrate these designs into a single, comprehensive design for the entire specialized optics (Block 55). The phase profiles for all 25 channels are arranged in a linear array, with each channel's position corresponding to the specific section of the input beam it will interact with.

These arranged phase profiles are then combined into a single, comprehensive phase profile for the entire SDCMS. This integration process ensures smooth transitions between channels while maintaining the individual functionality of each channel.

Using the integrated phase profile from step 55, this step involves designing the physical nanostructures that will make up the specialized optics (Block 56). The phase distribution is discretized and mapped onto a grid of nanopillars, nanoantennas, or similar nanostructures.

The heights, widths, and/or shapes of these nanostructures are carefully adjusted to produce both the desired light redistribution and the AOI correction simultaneously. These nanostructures vary across the SDCMS surface, reflecting the different phase profiles of each channel. The design process takes into account fabrication constraints and ensures that the transitions between channels are physically realizable.

The next step (Block 57) involves optimizing the fabrication library for a process to ensure compatibility with the SDCMS design. A fabrication library, in this context, refers to a set of pre-characterized nanostructure designs that can be reliably manufactured and produce specific optical effects. This library is used for translating the theoretical phase profile design into physically realizable structures.

Library grid optimization refers to the process of determining the optimal spacing and arrangement of nanostructures on the metasurface.

So that the fabrication process allows operation at 855 nm wavelength, a library grid optimization is performed. This involves simulating and analyzing various grid spacings to find one that provides the desired optical performance while being compatible with the fabrication constraints. A 450 nm grid has been found to perform well for this application. This optimization bridges the gap between the theoretical nanostructure design and practically fabricable structures.

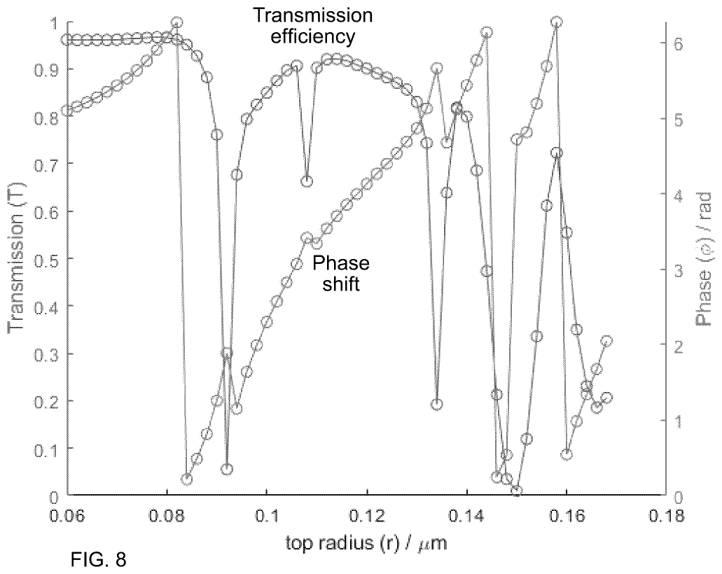

The graph in FIG. 8 illustrates the relationship between the top radius of the nanostructures and their transmission and phase characteristics for the optimized 450 nm grid library. The transmission efficiency, while the orange line shows the phase shift introduced by nanostructures of varying top radii. This graph is used to select the appropriate nanostructure dimensions that will produce the desired phase shifts while maintaining high transmission. For example, a nanostructure with a top radius of about 0.08μm provides a phase shift of approximately π radians (3.14 radians) with a transmission efficiency of nearly 100%.

The fabrication process used is a suitable manufacturing technique for creating metasurfaces. It involves lithography and etching processes that can produce nanostructures with high precision and consistency. The optimization of the fabrication library provides that the designed nanostructures can be accurately produced using this process.

Note that this optimization process may be adjusted based on the specific wavelength of the steering module with which the SDCMS will be integrated. Different wavelengths may utilize different grid spacings or nanostructure dimensions to achieve the desired optical performance.

The final step (Block 58) is the actual manufacturing of the SDCMS based on the nanostructure design from step 56 and the optimized fabrication library from step 57. During this process, a wide-angle Anti-Reflective Coating (ARC) may be applied to the sample, as this may provide better performance than the standard ARC or no ARC at all.

The resulting specialized optics contain all 25 channels seamlessly integrated into a single optical element, capable of creating the desired 2D scanning pattern from the 1D input scan. This manufactured specialized optics can accurately manipulate the incident light despite its non-normal angle of incidence, ensuring that the desired 2D scanning pattern is achieved from the 1D input scan. This approach enables the precise control of light distribution necessary for the system's efficient and accurate operation, even when dealing with angled incident light from the steering modules.

Finally, it is evident that modifications and variations can be made to what has been described and illustrated herein without departing from the scope of this disclosure. The same methodology could be used to design specialized optics for different scene sizes, number of targets, fields of view, and AOI corrections to suit various use cases.

Additionally, an alternative embodiment could utilize an array of refractive prisms in front of a metasurface imparting the desired directional functionality. Specifically, this alternative embodiment would be comprised of two distinct optical components working in tandem, namely, a refractive layer of prisms and a metasurface. The refractive layer of prisms is a conventional optical element made of a transparent material (such as glass or plastic) shaped into an array of small prisms. Each prism would be designed to refract the incoming light at a specific angle, correcting for the angle of incidence of the input beam. The metasurface would be placed immediately after the prism array, and would be responsible for imparting the desired directional functionality, manipulating the phase, amplitude, and/or polarization of the light that has already been refracted by the prism array. In this configuration, the prism array would handle the bulk of the AOI correction, while the metasurface would focus on the fine directional control and any additional wavefront manipulation required. This separation of functions could potentially simplify the design of each component.

Also, while the above-described embodiments utilize metasurface structures for the specialized optics, it should be noted that the principles of this disclosure are not limited to metasurfaces alone. In alternative embodiments, diffractive optical elements may be utilized instead of a metasurface. This approach uses quantized surface relief levels (depths) to act as phase levels, instead of a continuous phase, to implement the desired output of the optic.

Specifically, these specialized optics could, in one embodiment, be manufactured as a greyscale optic with any desired number of surface relief levels, up to and including a continuous surface profile, to impart a multitude of phase differences, allowing for fine-tuning of the optical output. A surface relief design achieves a phase difference by utilizing the difference in refractive index between the optic and air, and by the structured heights.

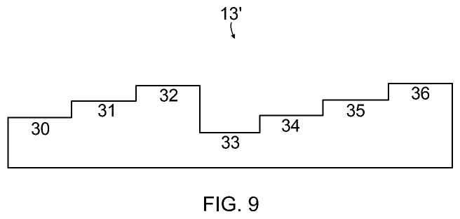

Illustrated in FIG. 9 is a cross-sectional view of a diffractive optical element (DOE) 13′ with 4 surface relief levels, capable of imparting 4 discrete phase differences. The DOE includes of 7 distinct sections, labeled 30 to 36, each representing one of the 4 possible surface relief levels. Sections 30 and 33 represent a base level, sections 31 and 34 are one step higher than the base level, sections 32 and 35 are two steps higher than the base level, and section 36 represents the highest level, three steps above the base level.

This stepped structure allows the DOE to impart four discrete phase differences to the incident light, corresponding to the four distinct height levels. The specific arrangement and widths of these sections are designed to produce the desired diffractive effect, redirecting and manipulating the incident light according to the principles described earlier for the SDCMS. These diffractive optics could potentially achieve similar spatial decoupling and beam manipulation effects, albeit through different physical mechanisms. The choice between metasurface and diffractive implementations may depend on factors such as manufacturing processes, cost considerations, and specific performance requirements of the LIDAR system. Although this disclosure has been described with a limited number of embodiments, those skilled in the art, having the benefit of this disclosure, can envision other embodiments that do not deviate from the disclosed scope. Furthermore, skilled persons can envision embodiments that represent various combinations of the embodiments disclosed herein made in various ways.

1. An optical system, comprising:
an optical arrangement comprising:
a light source;
a one-dimensional steering mechanism; and
optics configured to receive light from the one-dimensional steering mechanism and redirect the light to create a two-dimensional scanning pattern, wherein the optics comprise a plurality of channels, each channel configured to redirect light to a specific position in a target scene;
a light detector positioned to receive light that has reflected back from the target scene to impinge upon the light detector; and
control circuitry configured to determine a depth map of the target scene based upon the light that has reflected back from the target scene to impinge upon the light detector.

2. The optical system of claim 1, wherein the optics comprise a single optical element integrating all of the plurality of channels.

3. The optical system of claim 1, wherein the optics comprise Spatially Decohered Channel Optics (SDCO).

4. The optical system of claim 1, wherein the optics comprise a metasurface, and each channel of the metasurface comprises a plurality of nanostructures configured to modify a phase of incident light.

5. The optical system of claim 4, wherein dimensions of the plurality of nanostructures vary across the optics to produce desired phase shifts while maintaining high transmission efficiency.

6. The optical system of claim 1, wherein the optics are configured to correct for non-normal angles of incidence of light from the one-dimensional steering mechanism.

7. A method of operating an optical system, comprising:
emitting a light beam from a light source;
steering the light beam in a single dimension to perform a one-dimensional scan, using a one-dimensional scanner;
directing the steered light beam onto optics;
converting, by the optics, the one-dimensional scan into a two-dimensional scan across a scene;
detecting light reflected from the scene; and
generating a depth map of the scene based on the detected reflected light.

8. The method of claim 7, wherein the optics comprise Spatially Decohered Channel Optics (SDCO).

9. The method of claim 7, wherein the optics comprise a metasurface comprising a plurality of nanostructures configured to modify a phase of incident light.

10. The method of claim 7, wherein the optics comprise a diffractive optical element comprising a plurality of surface relief levels configured to modify a phase of incident light.

11. The method of claim 7, wherein converting the one-dimensional scan into a two-dimensional scan comprises:
redirecting the light beam to different horizontal and vertical positions in the scene using distinct optical channels integrated into the optics.

12. The method of claim 7, further comprising:
controlling a size and shape of a beam spot on each of a plurality of grid elements in the scene through structures in the optics.

13. The method of claim 12, wherein controlling the size and shape of the beam spot comprises:
incorporating diffusion structures in the optics to provide for desired coverage of each grid element by the light beam.

14. The method of claim 7, further comprising:
selectively illuminating given grid elements within the scene using the optics;
wherein selectively illuminating specific grid elements comprises:
fully illuminating some grid elements while leaving others dark; or
applying varying degrees of illumination across the scene.

15. An optical system, comprising:
a light source;
a one-dimensional steering mechanism; and
optics configured to receive light from the one-dimensional steering mechanism and redirect the light to create a two-dimensional scanning pattern, wherein the optics comprise a plurality of channels, each channel configured to redirect light to a specific position in a target scene.

16. The optical system of claim 15, wherein the optics comprise a single optical element integrating all of the plurality of channels.

17. The optical system of claim 15, wherein the optics comprise Spatially Decohered Channel Optics (SDCO).

18. The optical system of claim 15, wherein the optics comprise a metasurface, and each channel of the metasurface comprises a plurality of nanostructures configured to modify a phase of incident light.

19. The optical system of claim 15, wherein the optics are configured to correct for non-normal angles of incidence of light from the one-dimensional steering mechanism.

20. An optical device, comprising:
a plurality of distinct optical channels integrated into a single surface;
wherein each optical channel is configured to manipulate incident light in a given manner; and
wherein the optical device is configured to convert a one-dimensional scan of incident light into a two-dimensional scan across a target scene.

21. The optical device of claim 17, wherein each optical channel comprises an array of subwavelength nanostructures configured to modify at least one of phase, amplitude, and polarization of the incident light.

22. The optical device of claim 17, wherein the optical device is configured to decouple a direction of input light from a direction of output light.

23. The optical device of claim 17, further comprising a plurality of grid sections, each grid section corresponding to a discrete location in the target scene; wherein the optical device is configured to selectively illuminate specific grid sections.
